(19) United States
(12) Patent Application Publication
(10) Pub. No.: US 2024/0401846 A1
(43) Pub. Date: Dec. 5, 2024

(54) CATALYTIC HEATING SYSTEMS WITH SELF-HEATED CATALYTIC REACTORS AND METHODS OF OPERATING THEREOF

(71) Applicant: Proof Energy Inc., Fremont, CA (US)

(72) Inventors: Chunming Qi, Fremont, CA (US); Phuoc Nguyen, San Jose, CA (US)

(73) Assignee: Proof Energy Inc., Fremont, CA (US)

(21) Appl. No.: 18/326,612

(22) Filed: May 31, 2023

(51) Int. Cl. F24V 30/00; G05D 23/22; H05B 1/02

(52) U.S. Cl. CPC F24V 30/00; G05D 23/22; H05B 1/023

(57) ABSTRACT

Described herein are catalytic heating systems comprising self-heated catalytic reactors and methods of operating thereof. A self-heated catalytic reactor comprises a corrugated conductive layer and an insulator layer forming a stack (e.g., a wound stack) such that each pair of adjacent conductive layers in the stack is separated by an insulator layer. The self-heated catalytic reactor also comprises a catalyst layer, positioned on one or both conductive and insulator layers, and two electrodes electrically coupled to the conductive layer at the opposite ends. The catalyst layer is preheated by passing an electric current through the two electrodes and resistively heating the conductive layer, in some examples, supporting at least a portion of the catalyst layer. This internal heating reduces the time and energy required to bring the catalyst layer to its operating temperature, at which point the fuel can be introduced to provide additional heating.

### BACKGROUND

Catalytic heaters provide efficient heating with minimal pollutant emissions in comparison to fuel-fired/burning heaters due to the nature of catalytic reaction for complete fuel oxidation conversion at lower reaction temperature in the catalytic heaters. For example, fuel-fired heaters tend to operate at high temperatures causing uncontrolled nitrogen oxidation and other pollutants. As a result, catalytic heaters are more suitable for many environment-friendly applications, e.g., heating of various systems electrified medium-duty and heavy-duty vehicles.

However, a catalytic heater requires pre-heating of its catalyst (e.g., to at least 300° C. for ethanol) before the fuel and oxidant can be supplied into the heater in order for the heater to perform as desired. Conventionally, such pre-heating has been achieved using an externally-positioned resistive heater, e.g., a resistive-heating band wrapped around a catalytic heater. In this example, the resistive-heating band first heats the catalytic heater's housing, which then transfers the heat to the catalyst layer positioned inside the housing. The housing can have a significant thermal mass, which consumes a lot of energy for its heating and slows down the process of heating the catalyst layer. At the same time, integration of resistive heaters into the interior of catalytic heaters can be challenging due to high operating temperatures, available space, flow requirements, and the like.

### SUMMARY

Described herein are catalytic heating systems comprising self-heated catalytic reactors and methods of operating thereof. A self-heated catalytic reactor comprises a conductive layer (e.g., a corrugated conductive layer) and an insulator layer forming a stack (e.g., a wound stack) such that each pair of adjacent conductive layers in the stack is separated by an insulator layer. The self-heated catalytic reactor also comprises a catalyst layer, positioned on one or both conductive and insulator layers, and two electrodes electrically coupled to the conductive layer at the opposite ends. The catalyst layer is preheated by passing an electric current through the two electrodes and resistively heating the conductive layer. In some examples, the conductive layer supports at least a portion of the catalyst layer (e.g., with another portion supported by the insulator layer). Alternatively, the entire catalyst layer is supported by one or more other layers different from the conductive layer (e.g., the insulator layer) that are proximate but different from the conductive layer. This internal heating reduces the time and energy required to bring the catalyst layer to its operating temperature, at which point the fuel can be introduced to provide additional heating.

In some examples, a self-heated catalytic reactor comprises a conductive layer comprising a first end and a second end, opposite of the first end, wherein the first end and the second end define the length of the conductive layer. The self-heated catalytic reactor also comprises an insulator layer forming a stack together with the conductive layer, wherein each pair of adjacent layers of the conductive layer in the stack is separated by the insulator layer. The self-heated catalytic reactor further comprises a catalyst layer positioned on and supported on at least the conductive layer, a first electrode electrically coupled to the conductive layer at the first end, and a second electrode electrically coupled to the conductive layer at the second end.

In some examples, the stack is a wound stack forming a coil around the first electrode. More specifically, the stack may be a single-coil wound stack with the first electrode at least partially extending through a center of the stack. For example, the insulator layer is a single layer positioned on one side of the conductive layer. Alternatively, the stack may be a double-coil wound stack with both the first electrode and the second electrode positioned at an exterior of the stack. For example, the insulator layer comprises two portions positioned on different sides of the conductive layer.

In some examples, the stack is an accordion-style stack. For example, the insulator layer comprises multiple patches positioned on different sides of the conductive layer such that the patches on the first side of the conductive layer are offset relative to the patches on the second side, opposite of the first side.

In some examples, the self-heated catalytic reactor further comprises an enclosure housing the stack. Each of the first electrode and the second electrode protrudes through and is insulated from the enclosure. The conductive layer is insulated from the enclosure. In more specific examples, the conductive layer is insulated from the enclosure by at least one of (a) the insulator layer positioned between the conductive layer and the enclosure, or (b) an enclosure insulator positioned between the conductive layer and the enclosure. In some examples, the self-heated catalytic reactor further comprises an enclosure housing the stack and operable as the second electrode such that the conductive layer at the second end is electrically coupled to the enclosure.

In some examples, the catalyst layer is positioned on and supported by each of the conductive layer and the insulator layer. In the same or other examples, the conductive layer is formed from at least one of stainless steel, superalloy (INCONEL®), a FeCrAl alloy, and a conductive ceramic. In some examples, the conductive layer is configured to withstand a temperature of at least 1000° C. In the same or other examples, the conductive layer has a resistance of between 0.05 Ohm to 100 Ohm. In some examples, the conductive layer has a thickness of between 20 micrometers and 400 micrometers. In the same or other examples, the conductive layer is a corrugated conductive layer.

In some examples, the insulator layer is formed from at least one of ceramic, glass, mica, and a combination thereof. The insulator layer can be in the form of a sheet, a cloth, a screen, or a mat. In some examples, the self-heated catalytic reactor further comprises a fuel-oxidant mixer such that the first electrode and the second electrode protrude from the stack toward the fuel-oxidant mixer. In some examples, the first electrode, the second electrode, and the conductive layer have the same composition.

Also provided is a catalytic heating system using fuel and oxidant to generate heat. In some examples, the catalytic heating system comprises a self-heated catalytic reactor comprising a conductive layer, an insulator layer, a catalyst layer, a first electrode, and a second electrode. The conductive layer comprises a first end and a second end, opposite to the first end. The first end and the second end define the length of the conductive layer. The insulator layer forms a stack together with the conductive layer. Each pair of adjacent layers of the conductive layer in the stack is separated by the insulator layer. The catalyst layer is positioned on and supported on at least the conductive layer. The first electrode is electrically coupled to the conductive layer at the first end. The second electrode is electrically coupled to the conductive layer at the second end. In some examples, the catalytic heating system also comprises a power supply electrically coupled to the first electrode and the second electrode of the self-heated catalytic reactor. In some examples, the catalytic heating system further comprises a thermocouple configured to measure the temperature in the catalytic heating system corresponding to the temperature of the self-heated catalytic reactor. In some examples, the catalytic heating system comprises a system controller communicatively coupled to the power supply and the thermocouple and configured to instruct the power supply to provide electrical power between the first electrode and the second electrode in response to the temperature of the self-heated catalytic reactor received from the thermocouple.

In some examples, the catalytic heating system further comprises an externally-heated catalytic reactor connected in series with the self-heated catalytic reactor. The externally-heated catalytic reactor is positioned downstream from the self-heated catalytic reactor. The externally-heated catalytic reactor has a larger surface area than the self-heated catalytic reactor. The self-heated catalytic reactor is configured to heat the externally-heated catalytic reactor using heated gas and pass through fuel from the self-heated catalytic reactor to the externally-heated catalytic reactor.

In some examples, the catalytic heating system further comprises a fuel supply and an oxidant supply, wherein the self-heated catalytic reactor and the externally-heated catalytic reactor are integrated into a catalytic heater comprising a fuel-oxidant mixer fluidically coupled to each of the fuel supply and the oxidant supply.

In some examples, the catalytic heating system further comprises an additional catalytic heater comprising an additional self-heated catalytic reactor, an additional externally-heated catalytic reactor, and an additional fuel-oxidant mixer. The additional fuel-oxidant mixer is fluidically coupled to each exhaust of the catalytic heater and the oxidant supply. The additional self-heated catalytic reactor is electrically coupled to the power supply configured to provide electrical power between the additional self-heated catalytic reactor independently from the self-heated catalytic reactor and in response to the system controller.

Also provided is a method of operating a catalytic heating system comprising a self-heated catalytic reactor, a power supply, a thermocouple, and a system controller. The method comprises determining the temperature of the self-heated catalytic reactor using the thermocouple. The self-heated catalytic reactor comprises a conductive layer, an insulator layer, a catalyst layer, a first electrode, and a second electrode. The conductive layer comprises a first end and a second end, opposite to the first end. The first end and the second end define the length of the conductive layer. The insulator layer forms a stack together with the conductive layer. Each pair of adjacent layers of the conductive layer in the stack is separated by the insulator layer. In some examples, the catalyst layer is positioned on and supported by at least the conductive layer. The first electrode is electrically coupled to the conductive layer at the first end. The second electrode is electrically coupled to the conductive layer at the second end. The method also comprises activating the power supply and supplying electrical power between the first electrode and the second electrode using the power supply when the temperature of the self-heated catalytic reactor is below a first threshold, thereby resistively heating the conductive layer. The method further comprises flowing fuel and oxidant into the self-heated catalytic reactor when the temperature of the self-heated catalytic reactor reaches the first threshold. The method comprises deactivating the power supply and stopping supplying the electrical power between the first electrode and the second electrode when the temperature of the self-heated catalytic reactor reaches a second threshold.

In some examples, the second threshold is equal to the first threshold. The fuel and the oxidant flow into the self-heated catalytic reactor when the power supply is deactivated. In some examples, the second threshold is greater than the first threshold. The fuel and the oxidant flow into the self-heated catalytic reactor while the power supply remains activated.

In some examples, the first threshold is between 300° C. and 700° C. The fuel may be selected from the group consisting of methanol, ethanol, hydrogen, ammonia, gasoline, diesel, heating fuel, and natural gas. The oxidant may be one in the group consisting of ambient air, compressed air, and compressed oxygen.

These and other embodiments are described further below with reference to the figures.

### BRIEF DESCRIPTION OF THE DRAWINGS

FIG. 1A is a block diagram of a catalytic heating system comprising a self-heated catalytic reactor positioned upstream from an externally-heated catalytic reactor (e.g., heated by the exhaust from the self-heated catalytic reactor and reaction heat of fuel passing through the self-heated catalytic reactor), in accordance with some examples.

FIG. 1B is a block diagram of a 2-stage catalytic heating system such that each stage comprises a self-heated catalytic reactor, in accordance with some examples.

FIGS. 2A-2D are schematic cross-sectional views of different examples of a self-heated catalytic reactor comprising a wound stack formed by an insulator layer and a conductive layer.

FIG. 2E is a schematic cross-sectional view of a pre-wound folded stack comprising an insulator layer and a conductive layer such that the folded stack can be used to form a double-wound spiral, in accordance with some examples.

FIG. 2F is a schematic cross-sectional view of a stack comprising a conductive layer positioned between the two portions of an insulator layer and used to form a folded/accordion-type stack, in accordance with some examples.

FIG. 3A is a schematic cross-sectional view of a stack, in an extended/unfolded state, comprising a conductive layer and an insulator layer, in accordance with some examples.

FIG. 3B is a schematic expanded view of a portion of the stack in FIG. 3A, in accordance with some examples.

FIG. 3C is a schematic expanded view of a portion of the stack in FIG. 3A in the folded/wound state, in accordance with some examples.

FIG. 3D is a schematic expanded view of the stack in FIG. 3C with a catalyst layer added, in accordance with some examples.

FIG. 3E is a schematic expanded view of a stack in a folded/wound state such that the stack comprises a conductive layer, an insulator layer, an additional conductive layer (providing support to the insulator layer), and a catalyst layer, in accordance with some examples.

FIG. 4 is a process flowchart corresponding to a method of operating a catalytic heating system comprising a self-heated catalytic reactor, in accordance with some examples.

FIG. 5 is a schematic temperature profile, illustrating temperature change during different operating stages of the method in FIG. 4, in accordance with some examples.

FIG. 6 is a block diagram of a vehicle comprising a catalytic heating system comprising a self-heated catalytic reactor and operably connected to various other vehicle systems, in accordance with some examples.

FIG. 7 illustrates temperature profiles for various heating profiles for a self-heated catalytic reactor.

### DETAILED DESCRIPTION

In the following description, numerous specific details are set forth to provide a thorough understanding of the presented concepts. The presented concepts may be practiced without some or all of these specific details. In other instances, well-known process operations have not been described in detail so as to not unnecessarily obscure the described concepts. While some concepts will be described in conjunction with the specific embodiments, it will be understood that these embodiments are not intended to be limiting.

### INTRODUCTION

As noted above, catalyst layers of catalytic reactors need to be preheated to achieve desired operating conditions. Specifically, a catalyst layer needs to be preheated to a specific minimal temperature (determined by the catalyst, fuel, and desired catalyzed reactions) before this layer becomes operational (e.g., before fuel and oxidant can be supplied and come in contact with the catalyst). In some examples, upstream heating (e.g., in the form of the heated exhaust provided by an upstream component such as an internal combustion engine in a catalytic converter) can be used for such pre-heating. However, while such pre-heating is performed and before the catalyst layer is heated to a desired operating temperature, the catalyst layer remains inoperable or operates at undesirable conditions. Furthermore, upstream heating may not be available in some systems (e.g., catalytic heaters). In some examples, catalysts need to be heated to at least about 300° C. (e.g., when ethanol is used as fuel), at least about 500° C., or even at least about 700° C. for their desired operations.

A resistive heater can be used for pre-heating the catalyst layer before introducing any components (e.g., exhaust, syngas, fuel/oxygen mixture, etc.) into any catalytic reactor. However, it is desirable to reduce the time and energy needed for this pre-heating. A self-heated catalytic reactor, described herein, addresses these concerns by integrating a resistive-heating element directly into the reactor as a catalyst layer support. A self-heated catalytic reactor may be also referred to as an internally-heated catalytic reactor or an in-situ heated catalytic reactor. The initial heating (before fuel is provided and any exothermic reaction occurs) in such a catalytic reactor is provided by one or more internal components of this reactor. Specifically, a self-heated catalytic reactor comprises a conductive layer (e.g., a corrugated conductive layer), which supports a catalyst layer and is used as a resistive-heating element. It should be noted that other components surrounding the conductive layer, which are not resistively heated but which are closely positioned to the conductive layer (e.g., an insulator layer) can be also used for supporting at least some portions of the catalyst layer. Furthermore, additional conductive components (e.g., an additional conductive layer can be provided in a stack for supporting the insulator layer) can be operable as additional resistive-heating elements. In some examples, a conductive layer is a corrugated conductive layer, e.g., to provide flow channels for fuel, oxidant, and exhaust. In further examples, a corrugated conductive layer can be stacked with a non-corrugated (flat) conductive layer, e.g., the non-corrugated (flat) conductive layer can be used for supporting the insulator layer.

The self-heated catalytic reactor also comprises two electrodes electrically coupled or, more specifically, directly connected to the conductive layer at the opposite ends and used to pass the current through the conductive layer. Resistive heating, which may be also referred to as Joule heating or Ohmic heating, depends on the resistance (R) of the conductive layer, i.e., P=V²/R. A lower resistance helps to improve the power output at a constant voltage supply. At the same time, the resistance is proportional to the resistivity (ρ) and the length (L) of the conductive layer and inversely proportional to its cross-sectional area (A), i.e., R=ρ×L/A. As such, the resistive heating power output depends on these parameters, P=V²/ρ/L*A. Each one of these parameters of the conductive layer will now be described in more detail.

The resistivity (ρ) is a property of the material forming the conductive layer. It should be noted that resistivity (ρ) should be balanced with the length (L) and the cross-sectional area (A) or, more specifically, the width (W) of the conductive layer to ensure that enough catalyst is heated. Specifically, a combination of the length (L) and width (W) determines the surface area of the conductive layer available for the catalyst layer support (and, generally, a larger area is desirable to provide more exposure of the catalyst to fuel and oxygen). Furthermore, it should be noted that the material of the conductive layer should be sufficiently stable/inert to various environmental conditions to which the conductive layer is exposed (e.g., high temperature, oxidants, fuels, etc.). In some examples, the conductive layer is formed from stainless steel, INCONEL® Alloy, or a FeCrAl alloy. Additional material considerations for the conductive layer (e.g., temperature stability, shape) are described below.

The cross-sectional area (A) is a combination/product of the width (W) and the thickness (T) of the conductive layer. Ideally, the cross-sectional area (A) is selected for the desired resistance and for the desired resistive heating/power output. However, as noted above, the width (W) of the conductive layer determines the surface area of the conductive layer available for the catalyst layer support (and it may be desirable to heat as much of the catalyst layer as possible). At the same time, a certain minimum thickness (T) of the conductive layer is needed to ensure adequate mechanical support to the catalyst layer and provide the overall mechanical structure within the self-heated catalytic reactor. However, a larger thickness corresponds to a larger thermal mass of the conductive layer. Also, the thickness occupies the space within the reactor that would otherwise be available for catalyst layers and flow channels.

To address this tension, a self-heated catalytic reactor, which has a limited width of the conductive layer, may be positioned upstream from an additional catalytic reactor, which may not have any internal heating capabilities and may be referred to as an externally-heated catalytic reactor. This externally-heated catalytic reactor may have a much greater width thereby allowing a larger amount of catalyst to be supported in this reactor set (while reducing the thermal mass heated using the resistive heater). It should be noted that the flow direction in this set of catalytic reactors is parallel to their widths. In this example, the catalyst layer of the self-heated catalytic reactor is preheated using resistive heating, provided by the conductive layer. A fuel/oxidant mixture is then supplied into the self-heated catalytic reactor and generates (using actual catalytic oxidation) heated exhaust, which is then directed to and used for heating the downstream externally-heated catalytic reactor. In other words, the exhaust of the self-heated catalytic reactor provides external heating to this downstream reactor. As a result, the size or, more specifically, the width of the self-heated catalytic reactors can be minimized to enable this initial catalytic oxidation, which is then used for additional heating of the overall system. In some examples, the resistive heating and the catalytic oxidation heating can overlap in time until some further heating threshold (above the threshold at which the fuel can be introduced into the self-heated catalytic reactor).

The length (L) of the conductive layer is a factor in the packaging and dimensions of the self-heated catalytic reactor. In general, the smaller outside dimensions of the self-heated catalytic reactor are desired while the length (L) of the conductive layer or, more specifically, the current path length/resistance of the conductive layer needs to be sufficiently high to achieve adequate resistive heating. This tension is addressed by introducing an insulator layer that forms a stack together with the conductive layer. Specifically, each pair of adjacent layers of the conductive layer in the stack is separated by the insulator layer thereby ensuring that these adjacent layers are not electrically interconnected/shorted and that the current following the entire length of the conductive layer (i.e., between its opposite ends where the two electrodes are attached). Various types of stacks are within the scope, e.g., wound stacks, accordion stacks, and the like. Furthermore, a wound stack can be a single spiral or a double spiral as further described below. Overall, a stack of a conductive layer and an insulator layer helps to increase the effective/insulated length of the conductive layer thereby improving the resistive heating properties of the substrate. Furthermore, the corrugation of the conductive layer increases the electronic pathway (in addition to providing flow channels for fuel, oxidant, and exhaust) when the conductive layer is a corrugated conductive layer Examples of Catalytic Heating Systems

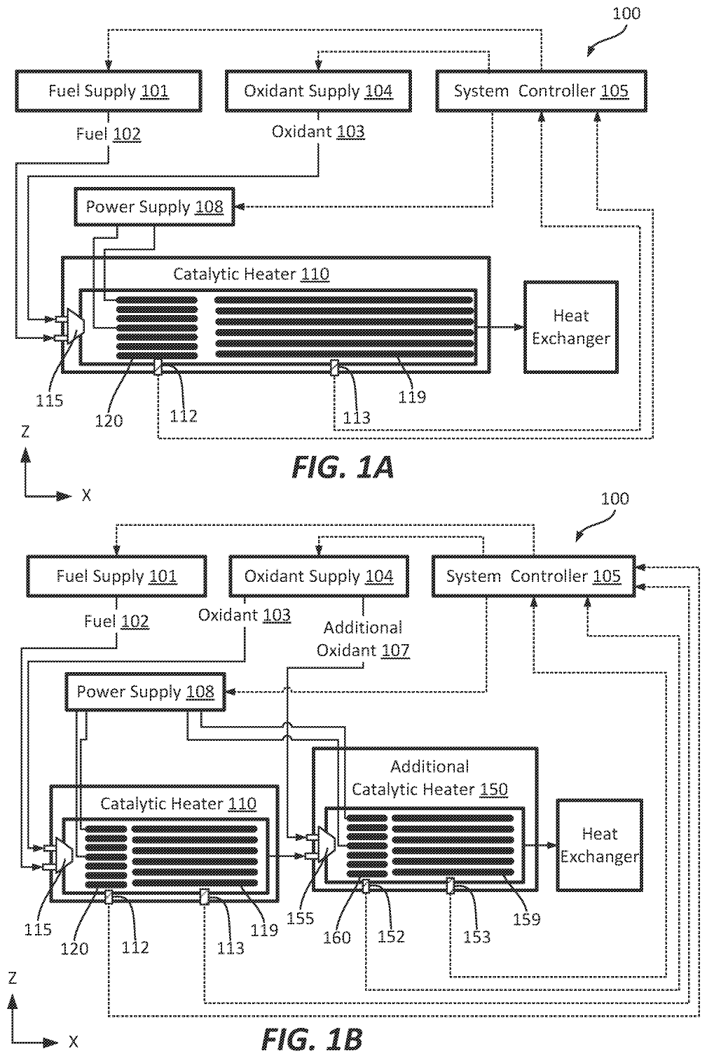

As noted above, one application example of a self-heated catalytic reactor is a catalytic heating system, which will be described with reference to FIGS. 1A and 1B. In general, a catalytic heating system uses fuel and oxidants to generate heat, in the form of a heated exhaust. However, other applications of self-heated catalytic reactors are also within the scope, such as catalytic converters (in exhaust systems coupled to internal-combustion systems), and fuel heaters for residential, commercial, and industrial.

Specifically, FIG. 1A is a block diagram of catalytic heating system 100 comprising self-heated catalytic reactor 120 integrated into catalytic heater 110. Self-heated catalytic reactor 120 receives fuel 102 (from fuel supply 101) and oxidant 103 (from oxidant supply 104) used for catalytic oxidation by self-heated catalytic reactor 120. In some examples, self-heated catalytic reactor 120 can be integrated together with externally-heated catalytic reactor 119, e.g., positioned downstream from self-heated catalytic reactor 120. FIG. 1B is a block diagram of catalytic heating system 100 comprising two catalytic heaters, i.e., catalytic heater 110 and additional catalytic heater 150 positioned downstream from catalytic heater 110. One or both catalytic heaters may be equipped with a self-heated catalytic reactor. This type of catalytic heating system 100 may be referred to as a dual-stage catalytic heating system comprising two catalytic heaters. For example, catalytic heater 110 can generate syngas that is sent to additional catalytic heater 150 together with additional oxidant 107.

In addition to catalytic heaters, catalytic heating system 100 comprises power supply 108. For example, power supply 108 can be electrically coupled to first electrode 121 and second electrode 122 of self-heated catalytic reactor 120 and used to drive the electric current through conductive layer 130 of self-heated catalytic reactor 120 thereby providing the resistive heating within self-heated catalytic reactor 120. In general, power supply 108 is configured to supply power to each self-heated catalytic reactor in catalytic heating system 100. In some examples, each self-heated catalytic reactor is independently powered. For example, FIG. 1B illustrates self-heated catalytic reactor 120 and additional self-heated catalytic reactor 160 electrically coupled to power supply 108 such that power supply 108 can provide different power levels to each reactor and/or at different times. In some examples, the two-reactor resistive pre-heating can start at the same time or the downstream heater can be started later.

In some examples, catalytic heating system 100 also comprises thermocouple 112, e.g., coupled to self-heated catalytic reactor 120 and configured to measure the temperature of self-heated catalytic reactor 120. For example, thermocouple 112 can be a part of catalytic heater 110. In some examples, catalytic heater 110 can comprise externally-heated catalytic reactor 119, which has its own second thermocouple 113 (configured to measure the temperature of externally-heated catalytic reactor 119). Furthermore, in some examples, catalytic heating system 100 comprises additional catalytic heater 150, comprising its own thermocouples, e.g., additional thermocouple 152 (configured to measure the temperature of additional self-heated catalytic reactor 160) and second additional thermocouple 153 (configured to measure the temperature of additional externally-heated catalytic reactor 159). The output of one or more of these thermocouples is used to control various operating sequences.

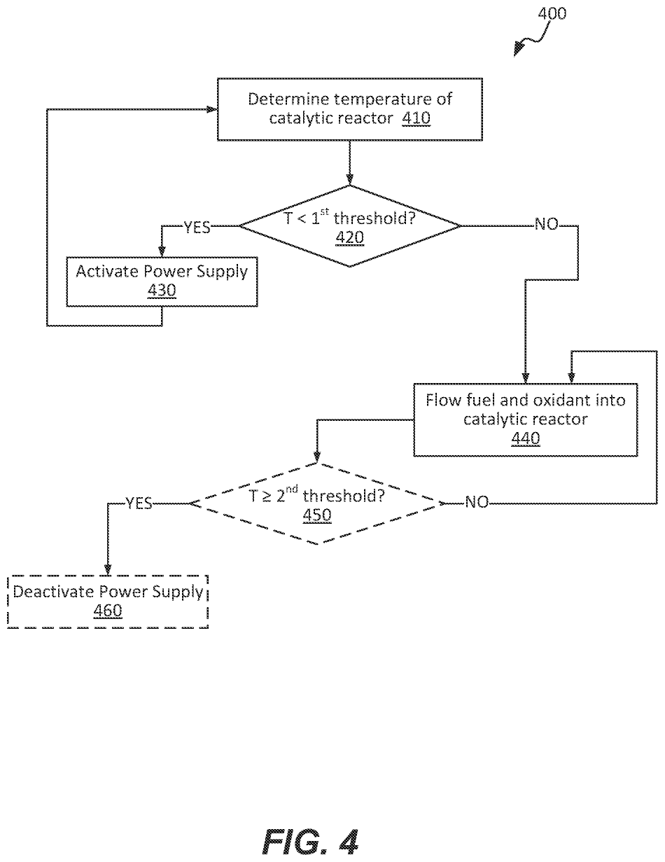

In some examples, catalytic heating system 100 also comprises system controller 105, communicatively coupled to power supply 108 and thermocouple 112. System controller 105 can be configured to instruct power supply 108 to provide electrical power between first electrode 121 and second electrode 122 in response to the temperature of self-heated catalytic reactor 120 received from thermocouple 112. Furthermore, system controller 105 can be configured to instruct fuel supply 101 and oxidant supply 104 to supply fuel 102 and oxidant 103, respectively, to catalytic heater 110 (and to additional catalytic heater 150, if one is present). In general, system controller 105 can be configured to execute various operations of a method of operating catalytic heating system 100 described below with reference to FIG. 4.

Referring to FIGS. 1A and 1B, in some examples, catalytic heating system 100 further comprises externally-heated catalytic reactor 119 connected in series with catalytic reactor 120. Externally-heated catalytic reactor 119 may be positioned downstream from self-heated catalytic reactor 120. As such, the exhaust from self-heated catalytic reactor 120 can be used for heating externally-heated catalytic reactor 119. Specifically, self-heated catalytic reactor 120 is configured to heat externally-heated catalytic reactor 119 using heated gas from self-heated catalytic reactor 120 to externally-heated catalytic reactor 119.

In some examples, externally-heated catalytic reactor 119 is wider (in the X-direction) tha self-heated catalytic reactor 120, e.g., at least twice wider, at least 5 times wider, or even at least 10 times wider. More specifically, externally-heated catalytic reactor 119 has a larger surface area tha self-heated catalytic reactor 120, e.g., at least twice larger, at least 5 times larger, or even at least 10 times larger. As noted above, the width of the self-heated catalytic reactor 120 can be controlled (minimized) to ensure the resistance of conductive layer 130 (and the resistive-heating power output) as well as the thermal mass that needs to be heated. At the same time, a larger catalyst-supporting surface is needed in the overall catalytic heating system 100, which can be achieved by using externally-heated catalytic reactor 119 or, more specifically, externally-heated catalytic reactor 119 that is much wider tha self-heated catalytic reactor 120.

As noted above, catalytic heating system 100 further comprises fuel supply 101 and oxidant supply 104, e.g., controlled using system controller 105. In some examples, fuel supply 101 one or more of these components can be also parts of another system, e.g., a vehicle. For example, fuel supply 101 or, more specifically, the fuel storage can be a vehicle fuel tank, the fuel filter can be a vehicle fuel filter, and the fuel delivery device can be a vehicle fuel pump. Some examples of fuel 102 include methanol, ethanol, hydrogen, and natural gas or, more specifically, bio-methanol, bio-ethanol, green hydrogen, biodiesel, biogas, propane, butane, ammonia, gasoline, diesel, heating fuel, and isopropanol. It should be noted that some of these fuel examples are renewable (e.g., bio-methanol, bio-ethanol, green hydrogen, biodiesel, and biogas).

In some examples, fuel supply 101 is a replaceable cartridge. Unlike conventional fuel tanks, replaceable cartridges do not require any specific emission controls when used in a vehicle or, more specifically, in catalytic heating system 100. A replaceable cartridge comprises a connecting port for connecting to the fuel line catalytic heating system 100. For example, a replaceable cartridge can be plugged into a fuel canister shell of the fuel supply. The shell can be mounted on a vehicle and would protect the replaceable cartridge from road hazards.

In some examples, oxidant supply 104 can comprise an oxidant storage, an oxidant filter, and/or an oxidant delivery device. In some examples, oxidant 103 is oxygen in the air, which is obtained from the environment. In these examples, the oxidant storage is not present. It should be noted that the air also contains nitrogen, which passes through catalytic heating system 100 substantially unreacted. Oxidant storage can be used when the ambient air is not available, e.g., in mining applications, underwater applications, and the like. Some features of oxidant supply can be provided by other vehicle systems, e.g., vehicle air filter, supercharger, turbocharger, and the like. Overall, oxidant 103 can be selected from the group consisting of ambient air, compressed air, and compressed oxygen.

Referring to FIG. 1B, in some examples, oxidant supply 103 is configured to split the supply into a first oxidant portion (labeled as oxidant 103 and delivered to catalytic heater 110) and into a second oxidant portion (labeled as additional oxidant 107 and delivered to additional catalytic heater 160). In more specific examples, the first oxidant flow rate and second oxidant flow rate are independently controlled, e.g., by oxidant supply 103.

Catalytic heater 110 comprises fuel-oxidant mixer 115 fluidically coupled to each of fuel supply 101 and oxidant supply 104. When additional catalytic heater 150 is present, additional catalytic heater 150 can comprise additional fuel-oxidant mixer 155, which can be fluidically coupled to oxidant supply 104 (e.g., for supplying additional oxidant 107) and to the exhaust of catalytic heater 110 (e.g., for supplying the syngas into additional catalytic heater 150)

Overall, referring to FIG. 1B, in some examples, catalytic heating system 100 further comprises additional catalytic heater 150 comprising additional self-heated catalytic reactor 160, additional externally-heated catalytic reactor 159, and additional fuel-oxidant mixer 115. Additional fuel-oxidant mixer 115 is fluidically coupled to each exhaust of catalytic heater 110 and oxidant supply 104. Additional self-heated catalytic reactor 160 is electrically coupled to power supply 108 configured to provide electrical power to additional self-heated catalytic reactor 160 independently from self-heated catalytic reactor 120 and in response to system controller 105.

For example, catalytic heater 110 can be used for a first-stage oxidation, which uses a fuel-rich mixture and which allows lowering the operating temperature. The fuel-rich mixture has an equivalence ratio of less than 1, e.g., less than 0.75 or even less than 0.6. Furthermore, additional catalytic heater 150 can be used for performing second-stage oxidation using a fuel-lean mixture, which also allows for lowering the operating temperature. The fuel-lean mixture has an equivalence ratio of greater than 1, e.g., greater than 1.5 or even greater than 1.75. The exhaust from the first stage (referred to as syngas) is combined with additional air upon entering the second-stage catalytic reactor. Carbon monoxide and hydrogen in the syngas are fully oxidized (using additional oxygen from the air) to form carbon dioxide and water, respectively. Carbon dioxide, water, and some remaining oxygen (oxygen excess in the fuel-lean mixture) form exhaust, which can be used to recover heat.

Overall, the two-stage catalytic heating system allows for avoiding excessive temperatures during the overall oxidation process. As noted above, these higher temperatures are associated with an equivalence ratio of about 1 and cause nitrogen oxides and other pollutants. A fuel mixture in each catalytic reactor is specifically controlled by the fuel and oxidant flow rates to achieve either a fuel-rich condition (in the first-stage catalytic reactor) or a fuel-lean condition (in the second-stage catalytic reactor).

### Examples of Self-Heated Catalytic Reactors

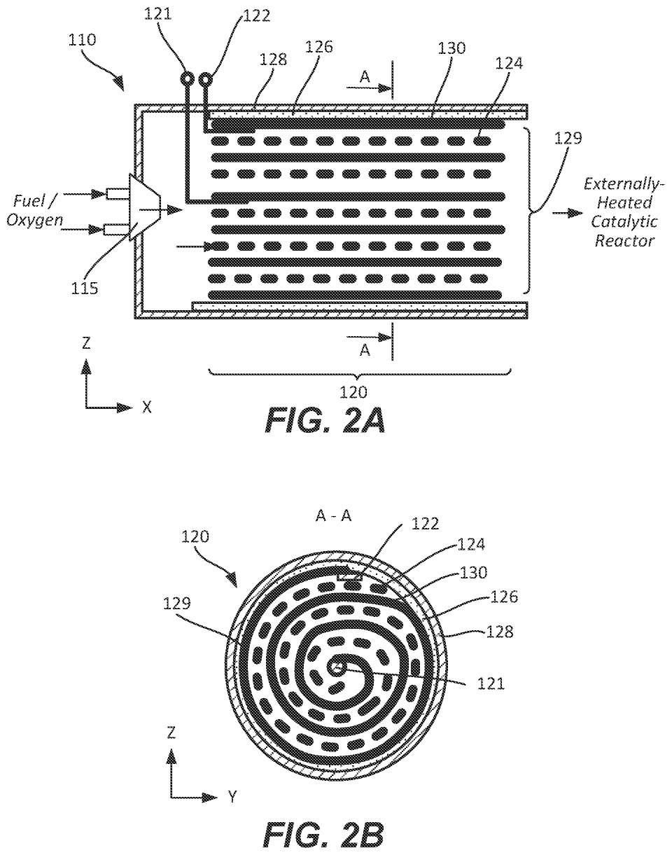

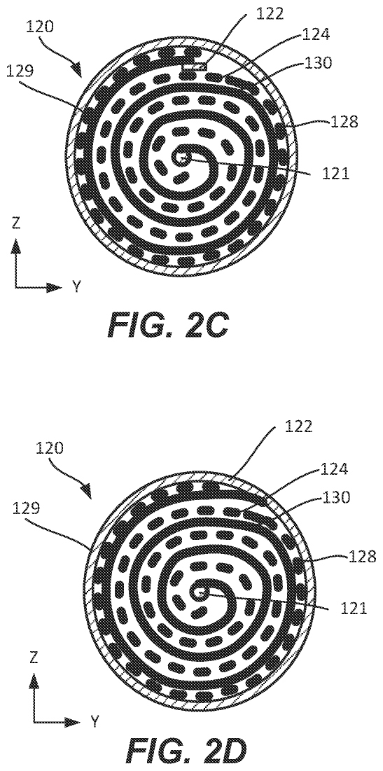

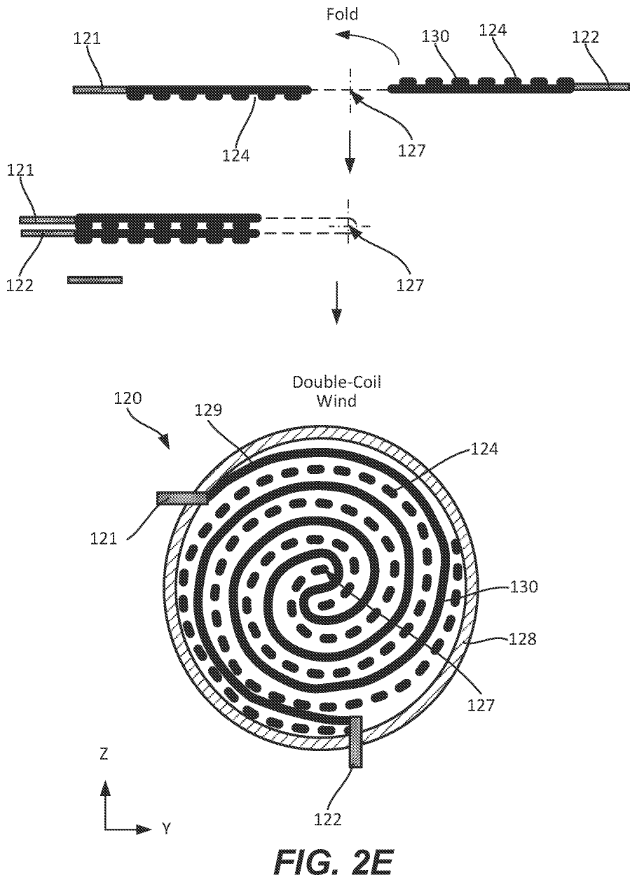

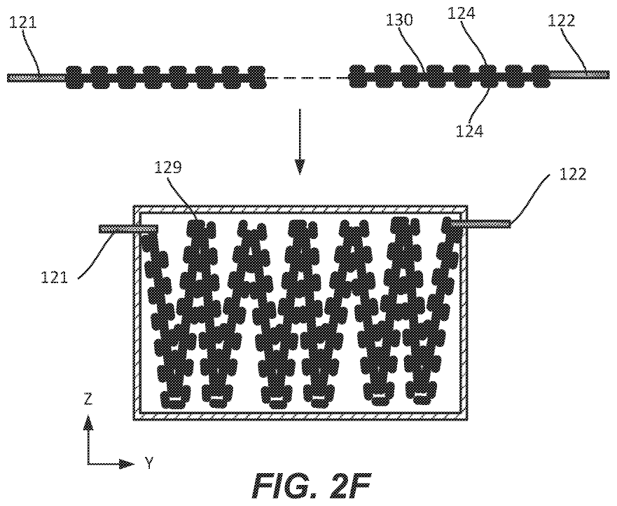

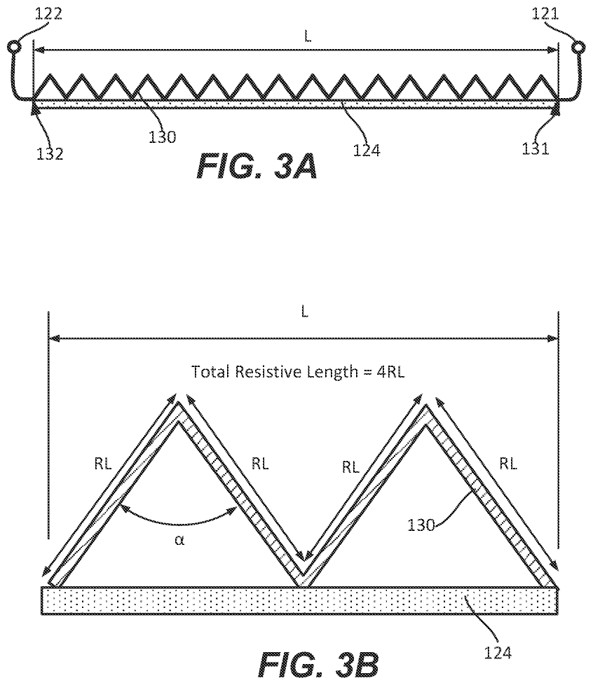

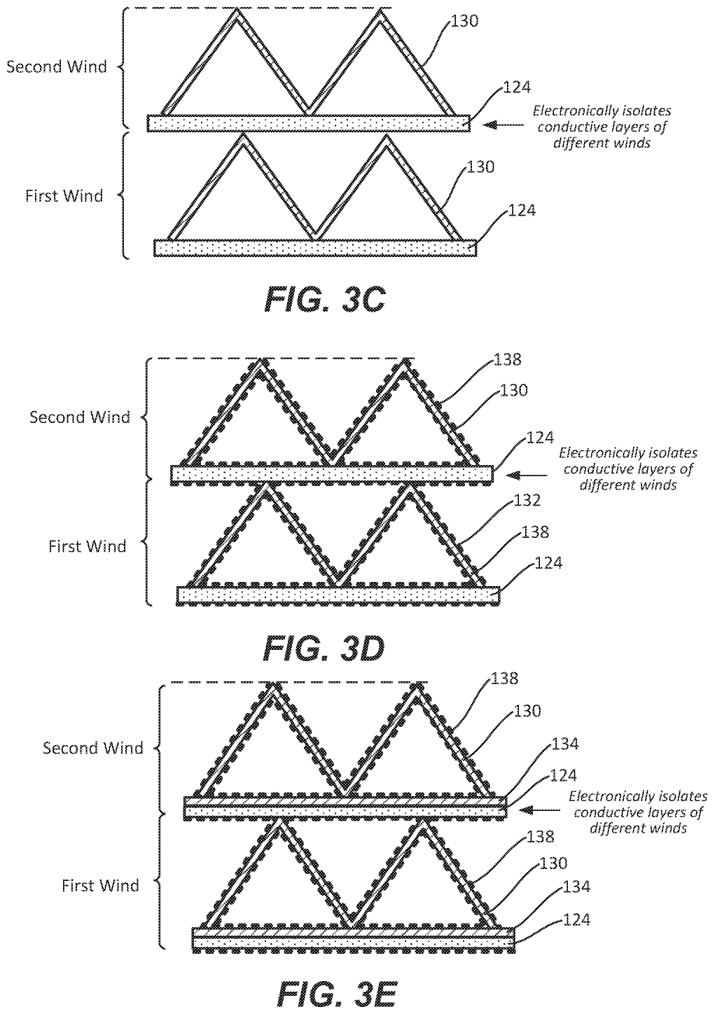

Various examples and features of self-heated catalytic reactor 120 will now be described with reference to FIGS. 2A-3E. Self-heated catalytic reactor 120 comprises at least conductive layer 130, insulator layer 124, catalyst layer 138, first electrode 121, and second electrode 122. In some examples, portions of conductive layer 130 can be operable as first electrode 121 and/or second electrode 122.

Conductive layer 130 comprises first end 131 and second end 132, opposite of first end 131. First end 131 and second end 132 define the length of conductive layer 130, e.g., as schematically shown in FIG. 3A shows a combination of conductive layer 130 and insulator layer 124 in an unstacked/unwound form. The insulator layer 124 forms stack 129 together with conductive layer 130 with various examples of stack 129 shown in FIGS. 2A-2F and described below. It should be noted that even though the length of conductive layer 130 does not change during the stacking, the distance between first end 131 and second end 132 (e.g., first end 131 and second end 132 are positioned closer together).

Regardless of the stack type, each pair of adjacent layers of conductive layer 130 in stack 129 is separated by insulator layer 124 thereby ensuring that the current pathway corresponds to the length of conductive layer 130 (regardless of the stacking configuration). Catalyst layer 138 is positioned on and supported by at least conductive layer 130 or each of conductive layer 130 and insulator layer 124 (e.g., when catalyst infiltration is performed after forming the stack). First electrode 121 is electrically coupled (e.g., directly connected) to conductive layer 130 at first end 131 (and can be electrically coupled to power supply 108). Second electrode 122 is electrically coupled (e.g., directly connected) to conductive layer 130 at second end 132 (and can be also electrically coupled to power supply 108). In some examples, the electrical coupling can be provided by various other components.

Various types of stacks (formed by conductive layer 130 and insulator layer 124) are within the scope, e.g., a wound stack, and an accordion-type stack. The wound stack example is generally shown in FIG. 2A and can include a single-wound spiral (shown in FIGS. 2B-2D) and a double-wound spiral (shown in FIG. 2E). An example of the accordion-type stack is shown in FIG. 2F. The wound stack may be also referred to as a “jellyroll.” The wound spiral can be a metal sheet or foil, screen, perforated metal sheet, and metal foam.

Referring to FIGS. 2B-2D, the single-wound spiral can be formed by a stack in which insulator layer 124 is positioned on one side of conductive layer 130 (e.g., shown in FIGS. 3A-3E). In this stack example, stack 129 forms a coil around first electrode 121 (e.g., shown in FIGS. 2B-2D). In other words, first electrode 121 is positioned in the center of the stack and can at least partially protrude through the center of this wound stack and is a part of the innermost wind. Second electrode 122 is a part of the outermost wind and can be positioned proximate to enclosure 128 of self-heated catalytic reactor 120.

In some examples, first electrode 121 and second electrode 122 protrude through enclosure 128 without forming electrical connections to enclosure 128 (e.g., as shown in FIG. 2A). Even though second electrode 122 is proximate to the enclosure, second electrode 122 can be insulated from the enclosure by enclosure insulator 126 (e.g., as shown in FIG. 2B) and/or by insulator layer 124 (e.g., as shown in FIG. 2C, where insulator layer 124 is forming the outermost wind and the surface of the wound stack). Alternatively, second electrode 122 is connected to enclosure 128 (e.g., as shown in FIG. 2D). In other words, enclosure 128 is a part of second electrode 122 in this example.

Referring to FIG. 2E, in some examples, stack 129 is a double-coil wound stack with both first electrode 121 and second electrode 122 positioned at an exterior of stack 129 (e.g., proximate to enclosure 128). Such electrode orientation helps with forming electrical connections to these electrodes and also positions these connections away from the fluidic path (of the fuel and oxidant). To ensure the electrical separation in each coil of this double-coil stack, insulator layer 124 has two parts, positioned on different sides and at different locations of conductive layer 130. These positions are defined by fold axis 127 of stack 129. Specifically, one part of insulator layer 124 is positioned on the first side of conductive layer 130 and extends in a first direction from fold axis 127, while the other part of insulator layer 124 is positioned on the second side (opposite of the first side) of conductive layer 130 and extends in the second direction (opposite of the second direction) from fold axis 127, e.g., as schematically shown in the top view in FIG. 2E. To form stack 129, conductive layer 130 and the two parts of insulator layer 124 can be arranged as shown in this view and then folded about fold axis 127 thereby forming a folded subassembly shown in the middle view in FIG. 2E. Thereafter, the folded subassembly is wound about fold axis 127 into a double-coil wound stack as shown in the bottom view in FIG. 2E

Referring to FIG. 2F, in some examples, stack 129 is an accordion-type stack, which may be also referred to as a Z-folded stack or a zig-zag folded stack. To ensure the electrical separation in each fold of this stack 129, insulator layer 124 has at least two parts, positioned at different sides of conductive layer 130. In some examples, insulator layer 124 is patched such that the length of each patch and the pitch (the gap between any two adjacent patches) corresponds to the width of each fold. In these examples, only one portion of insulator layer 124 is positioned between two adjacent folded portions of conductive layer 130. Alternatively, as shown in FIG. 2F, insulator layer 124 has two parts, each continuously extending along the entire length of conductive layer 130. In this example, each fold has two separator portions positioned between adjacent portions of conductive layer 130.

Regardless of the stack type, each pair of adjacent portions of conductive layer 130 is separated by insulator layer 124. As noted above, insulator layer 124 prevents the electrical contact between these adjacent portions thereby forcing the electric current to travel the entire length of conductive layer 130 thereby correlating the length of conductive layer 130 with its resistive-heating output (P=V²/R). Without insulator layer 124, the current distribution without a stacked form of conductive layer 130 will be different as the current will take the least resistive path between the connection points.

In some examples, self-heated catalytic reactor 120 further comprises enclosure 128 housing stack 129. Enclosure 128 can have various cross-sectional shapes (e.g., circular, rectangular, oval) and can be made from different materials (e.g., Superalloy and stainless steel). In some examples, enclosure 128 also houses another catalytic reactor, e.g., externally-heated catalytic reactor 119 (two or more reactors sharing the same enclosure).

In some examples, conductive layer 130 is insulated from enclosure 128. For example, conductive layer 130 is insulated from enclosure 128 by at least one of (a) enclosure insulator 126 positioned between conductive layer 130 and enclosure 128 (e.g., as shown in FIG. 2B) and (b) insulator layer 124 positioned between conductive layer 130 and enclosure 128 (e.g., as shown in FIG. 2C). Enclosure insulator 126 can be also used for providing a thermal insulator and/or isolate enclosure 128 from various materials flowing through self-heated catalytic reactor 120 (e.g., fuel, oxidant, exhaust, etc.). Various materials for enclosure 128 are within the scope, e.g., especially when enclosure insulator 126 provides thermal/chemical separation from the internal environment of self-heated catalytic reactor 120.

### Examples of Conductive Layers and Insulator Layers

The material of conductive layer 130 has to withstand high operating temperatures of self-heated catalytic reactor 120 and be sufficiently resistive to ensure the resistive heating features described above. In some examples, conductive layer 130 is formed from at least one of stainless steel (e.g., 441 Alloy), super alloy (e.g., INCONEL® Alloy), a FeCrAl alloy, and conductive ceramics (e.g., silicon carbide).

In some examples, conductive layer 130 is configured to withstand a temperature of at least 800° C., at least 1000° C., or at least 1200° C. In other words, conductive layer 130 retains its mechanical and electrical properties when exposed to such temperatures.

In general, lower operating temperatures of these reactors allow using metallic support, rather than ceramic support, which is common in a conventional catalytic converter. In comparison to ceramic supports, metallic supports are more robust to vibration and temperature fluctuations. Furthermore, metallic supports have better thermal conductivity, which is important for catalyst preheating and maintaining uniform temperature throughout the entire catalyst. The metallic supports may be specifically configured to balance the flow rate through the reactor and the operating surface area. Finally, metallic supports can be used as resistive heaters.

In some examples, conductive layer 130 has a resistivity of at least 1×10⁻⁷ Ohm-m or, more specifically, at least 2×10⁻⁷ Ohm-m, or even at least 5×10⁻⁷ Ohm-m. As a reference, the resistivity of stainless steel is 6.9×10⁻⁷ Ohm-m, the resistivity of INCONEL® Alloy 718=12.5×10⁻⁷ Ohm-m, while the resistivity of copper is 0.168×10⁻⁷ Ohm-m. In other words, materials like copper and aluminum are too conductive to be used as conductive layer 130. Furthermore, copper and aluminum have low melting points (e.g., 1085° C. and 660° C. respectively) and, therefore, are not suitable for use in catalytic reactors. The conductive layer electric resistance is between 0.05 Ohm to 100 Ohm, more specifically, 0.1 Ohm to 10 Ohm, and even more specifically 0.2 Ohm to 2 Ohm.

In some examples, first electrode 121, second electrode 122, and conductive layer 130 have the same composition (some examples of which are described above). Alternatively, first electrode 121 and second electrode 122 are made from a different material (e.g., a lower resistance material) than conductive layer 130. For example, first electrode 121 and second electrode 122 are made from nickel. First electrode 121 and second electrode 122 can be in a form of a rod, a bar, a sheet, or a wire bundle. First electrode 121 and second electrode 122 can be connected to conductive layer 130 by welding, brazing, and tight fit.

In some examples, conductive layer 130 has a length between first electrode 121 and second electrode 122 of at least about 1 meter, at least about 2 meters, or at least about 2.5 meters. As noted above, while a larger length may be desirable to increase the resistive-heating output and provide a larger surface for catalyst layer 138, this length may be restricted by the overall dimension (e.g., the diameter) of self-heated catalytic reactor 120, the thickness of conductive layer 130, and other factors.

In the same or other examples, conductive layer 130 has a thickness of between 20 micrometers and 400 micrometers or, more specifically, between 50 micrometers and 100 micrometers. Various thickness considerations (e.g., impact on the resistance, and mechanical support are described above). In the same or other examples, conductive layer 130 has a width of between 0.5 centimeters and 20 centimeters or, more specifically, between 1 centimeter and 10 centimeters. As noted above, reducing the width of conductive layer 130 (and the width of the self-heated catalytic reactor 120) helps to reduce the thermal mass that needs to be heated (and reduces the amount of heating required). However, the width also restricts the amount of catalyst pre-heated and may require another heating stage (using the exhaust from this pre-hated catalyst). Alternatively, in some examples, all catalyst layers in catalytic heating system 100 are pre-heated using the resistive-heating method described herein (e.g., when electric power is readily available, longer ramp-up time is a concern, exhaust composition during the ramp-up is a concern).

Referring to FIG. 3B, the corrugation feature of conductive layer 130 increases the electronic pathway (“corrugated length”) relative to the projection (“flat length”). In some examples, the ratio of the corrugated length/flat length is at least 1.2, at least 1.3, at least 1.5, or even at least 2. This corrugated/flat ratio depends on the corrugation angle (a), which can be at least 300, at least 450, or even at least 60°. As noted above this corrugation feature also provides flow channels through the stack, e.g., as schematically shown in FIGS. 3C-3D.

One having ordinary skills in the art would understand that the dimensions described above can be scaled based on the size of each catalytic heating system 100. However, different dimensions play different roles in resistive heating as presented in the following table.

TABLE
Resistive Heating Modeling of Different
Corrugated and Flat Conductive Layers

| Material | FeCrAl | FeCrAl | SS441 | SS441 |
|---|---|---|---|---|
| Power, W | 480 | 960 | 480 | 960 |
| Voltage, V | 24 | 24 | 24 | 24 |
| Current, A | 20 | 40 | 20 | 40 |
| Resistance, Ohm | 1.2 | 0.6 | 1.2 | 0.6 |
| Resistivity, micro · Ohm · m | 1.4 | 1.4 | 0.587 | 0.587 |
| Thickness, mm | 0.1 | 0.1 | 0.1 | 0.1 |
| Corrugated/flat, length ratio | 1.5 | 1.5 | 1.5 | 1.5 |
| Length, m | 2.7 | 2.7 | 2.7 | 2.7 |
| width, cm | 1.89 | 3.78 | 0.79 | 1.58 |

In some examples, insulator layer 124 is formed from at least one of ceramic (e.g., alumina), glass, and mica. Similar to conductive layer 130, insulator layer 124 has to be stable to various operating conditions of self-heated catalytic reactor 120 (e.g., temperatures, fuel/oxidant/exhaust conditions), while retaining its electrical and mechanical properties. Insulator layer 124 can be in the form of a sheet, a cloth, or a mat. In some examples, insulator layer 124 is also used for supporting catalyst layer 138, e.g., as shown in FIG. 3D.

In some examples, catalyst layer 138 comprises rhodium, ceria, platinum, and/or palladium on alumina, which is coated on layers 130, 124, and 134. For example, rhodium and/or ceria can be used in catalytic heater 110 while platinum and/or palladium can be used in additional catalytic heater 150 (e.g., operating at different temperatures/fuel-oxidation ratios).

In some examples, catalyst layer 138 is operable as insulator layer 124. In other words, the same component/structure is used as both catalyst layer 138 and insulator layer 124. For example, catalyst layer 138 can be coated onto conductive layer 130 at which point this coated assembly can be wound or stacked without adding any other components.

Referring to FIG. 3E, in some examples, self-heated catalytic reactor 120 comprises additional conductive layer 134, which might not be corrugated. For example, additional conductive layer 134 can be used for supporting insulator layer 124. It should be noted that additional conductive layer 134 provides an additional current pathway and can provide additional resistive heating. Specifically, sections of conductive layer 130 and additional conductive layer 134 can operate as interconnected parallel resistors. One having ordinary skill in the art would understand how to determine the total resistive-heating power output of the combination of conductive layer 130 and additional conductive layer 134 can.

In some examples, conductive layer 130 and additional conductive layer 134 are made from the same materials. Alternatively, the materials of conductive layer 130 and additional conductive layer 134 are different. The thickness of conductive layer 130 and additional conductive layer 134 can be the same or different.

### Method Examples

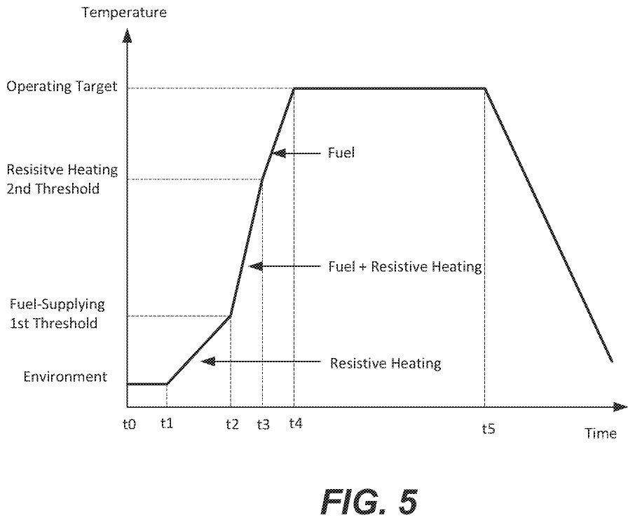

FIG. 4 is a process flowchart corresponding to method 400 of operating catalytic heating system 100, in accordance with some examples. Various features and examples of catalytic heating system 100 are described above. For example, catalytic heating system 100 can include self-heated catalytic reactor 120, power supply 108, thermocouple 112, and system controller 105. FIG. 5 illustrates the temperature of catalytic heating system 100 (e.g., the temperature of self-heated catalytic reactor 120 at various stages of this method).

In some examples, method 400 comprises (block 410) determining the temperature of self-heated catalytic reactor 120 using thermocouple 112. This temperature information may be forwarded to system controller 105 for determining if the resistive-heating capabilities of self-heated catalytic reactor 120 need to be used for heating self-heated catalytic reactor 120 to at least a first threshold at which the fuel and oxidant can be supplied into self-heated catalytic reactor 120. This first threshold may be also referred to as a fuel-supplying threshold. In some examples, the first threshold is between 200° C. and 600° C. or, more specifically, between 250° C. and 500° C., or even between 300° C. and 400° C.

In some examples, method 400 comprises (decision block 420) determining when the temperature of self-heated catalytic reactor 120 is below the first threshold. When the temperature of self-heated catalytic reactor 120 is below the first threshold, method 400 proceeds with (block 430) activating power supply 108 and supplying electrical power between first electrode 121 and second electrode 122 using power supply 108 thereby resistively heating conductive layer 130. It should be noted that the operations represented by various blocks in this process flowchart are performed simultaneously.

Referring to FIG. 5, catalytic heating system 100 can be initially idle (between t0 and t1) such that its temperature may be similar to that of the environment. This temperature may be lower than the first threshold, and power supply 108 can be activated at t1. The temperature is increased between t1 and t2 due to the resistive heating capabilities of self-heated catalytic reactor 120.

Returning to FIG. 4, when the temperature of self-heated catalytic reactor 120 reaches the first threshold, method 400 proceeds with (block 440) flowing fuel 102 and oxidant 103 into self-heated catalytic reactor 120. For example, fuel 102 can be selected from the group consisting of as methanol, ethanol, and natural gas or, more specifically, bio-methanol, bio-ethanol, and biogas. Other fuel examples include, but are not limited to, propane, butane, and isopropanol. It should be noted that some of these fuel examples are renewable (e.g., bio-methanol, bio-ethanol, and biogas).

Fuel 102 oxidizes at catalyst layer 138 (which is an exothermic reaction) providing additional heating with catalytic heating system 100 (as schematically shown by a portion of the temperature provide between t1 and t2 in FIG. 5). It should be noted that power supply 108 can stay activated after t1 (as in the FIG. 5 example) or may be turned off as soon as fuel 102 and oxidant 103 are flowed into self-heated catalytic reactor 120.

In some examples, method 400 comprises (decision block 450) determining when the temperature of self-heated catalytic reactor 120 reaches a second threshold. This second threshold may be referred to as the resistive-heating deactivation threshold. Specifically, self-heated catalytic reactor 120 can be fully operational at this point (with the fuel and oxidant being supplied) and further heating is provided by the exothermic reactions occurring at catalyst layer 134. As such, when the temperature of self-heated catalytic reactor 120 reaches the second threshold, method (400) proceeds with (block 460) deactivating power supply 108 and stop supplying the electrical power between first electrode 121 and second electrode 122 as shown in FIG. 5 by point t3. It should be noted that the temperature of self-heated catalytic reactor 120 can continue to change/increase thereafter, e.g., until reaching some operating target (stable state) as shown in FIG. 5 by point t3.

It should be noted that this second-threshold determination operation is optional. In some examples, power supply 108 is deactivated when the temperature of self-heated catalytic reactor 120 reaches the first threshold. In other words, the second threshold is equal to the first threshold. In this example, fuel 102 and oxidant 103 flow into self-heated catalytic reactor 120 when power supply 108 is deactivated. Alternatively, power supply 108 remains activated for some time after fuel 102 and oxidant 103 flow into self-heated catalytic reactor 120. For example, the second threshold is greater than the first threshold.

### Vehicle Integration Examples

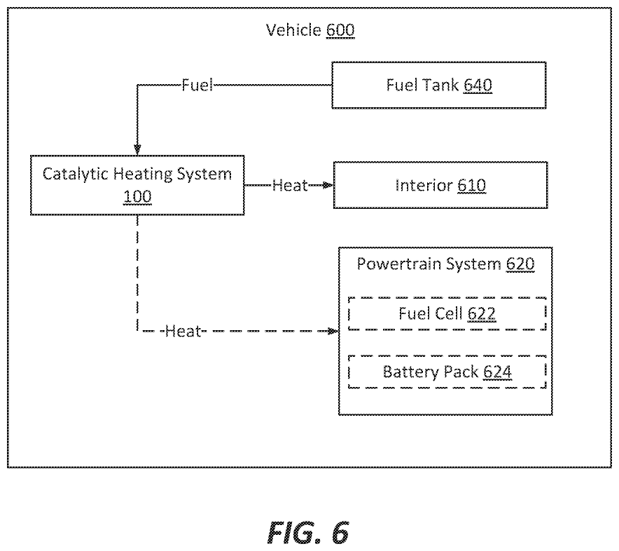

FIG. 6 is a block diagram illustrating various examples of integrating catalytic heating system 100 into vehicle 600. For example, catalytic heating system 100 can be used to supply heat to interior 610 of vehicle 600 (e.g., to maintain the interior temperature at the desired level, to defrost windows, and the like). Specifically, the heat (e.g., in the form of a heater fluid) can be pumped between catalytic heating system 100 (wherein the fluid is heated) and a radiator (wherein the fluid is cooled to heat air). The radiator may be coupled to an air blower, which directs the heated air from the radiator into the vehicle cabin. In the same or other examples, catalytic heating system 100 can be used to supply heat to powertrain system 620 or, more specifically, to fuel cell 622 and/or battery pack 624. One having ordinary skill in the art would appreciate that the operating temperature of battery pack 624 can deviate from the environmental temperature (e.g., vehicle 600 is parked outside during a winter night). To achieve the efficient operation of battery pack 624, the fluid can be pumped between catalytic heating system 100 and battery pack 624 to bring battery pack 624 to the operating temperature.

In some examples, vehicle 600 is equipped with fuel tank 640, e.g., an internal combustion vehicle, or a plug-in hybrid vehicle. Fuel tank 640 can be used to supply the fuel to catalytic heating system 100, effectively eliminating the need for a separate fuel supply at the heating system level. A similar integration can be used on the oxidant supply side.

### Experimental Results

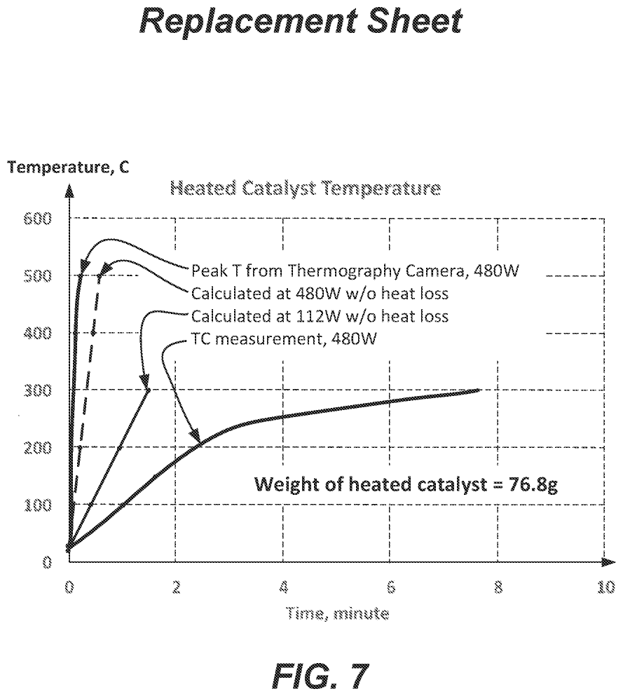

Various experiments have been conducted using a self-heated catalytic reactor to heat the catalyst weighing about 76.8 g. Specifically, this self-heated catalytic reactor was formed using a corrugated conductive layer having a length of 2670 mm and width of 18 mm and made from FeCrAl. The self-heated catalytic reactor was tested using two different power outputs of the power supply 480W and 112W. Actual temperature profiles and modeled temperature profiles are presented in FIG. 7. The experiment at 112W showed that the general concept and the tested sample work well. However, the time to reach the required temperature is too long. The experiment at 480W showed that the heated catalyst can reach the desired temperature sufficiently fast.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatuses. Accordingly, the present embodiments are to be considered illustrative and not restrictive.

1. A self-heated catalytic reactor comprising:
a conductive layer comprising a first end and a second end, opposite of the first end, wherein the first end and the second end define a length of the conductive layer;
an insulator layer forming a stack together with the conductive layer, wherein each pair of adjacent layers of the conductive layer in the stack is separated by the insulator layer, and
a catalyst layer positioned on and supported on at least the conductive layer;
a first electrode electrically coupled to the conductive layer at the first end; and
a second electrode electrically coupled to the conductive layer at the second end.

2. The self-heated catalytic reactor of claim 1, wherein the stack is a wound stack forming a coil around the first electrode.

3. The self-heated catalytic reactor of claim 2, wherein the stack is a single-coil wound stack with the first electrode at least partially extending through a center of the stack.

4. The self-heated catalytic reactor of claim 3, wherein the insulator layer is a single layer positioned on one side of the conductive layer.

5. The self-heated catalytic reactor of claim 2, wherein the stack is a double-coil wound stack with both the first electrode and the second electrode positioned at an exterior of the stack.

6. The self-heated catalytic reactor of claim 5, wherein the insulator layer comprises two portions positioned on different sides of the conductive layer.

7. The self-heated catalytic reactor of claim 1, wherein the stack is an accordion-style stack.

8. The self-heated catalytic reactor of claim 7, wherein the insulator layer comprises multiple patches positioned on different sides of the conductive layer such that the patches on a first side of the conductive layer are offset relative to the patches on a second side, opposite of the first side.

9. The self-heated catalytic reactor of claim 1, further comprising an enclosure housing the stack, wherein:
each of the first electrode and the second electrode protrudes through and is insulated from the enclosure, and
the conductive layer is insulated from the enclosure.

10. The self-heated catalytic reactor of claim 9, wherein the conductive layer is insulated from the enclosure by at least one of:
the insulator layer positioned between the conductive layer and the enclosure, or an enclosure insulator positioned between the conductive layer and the enclosure.

11. The self-heated catalytic reactor of claim 1, further comprising an enclosure housing the stack and operable as the second electrode such that the conductive layer at the second end is electrically coupled to the enclosure.

12. The self-heated catalytic reactor of claim 1, wherein the catalyst layer is positioned on and supported by each of the conductive layer and the insulator layer.

13. The self-heated catalytic reactor of claim 1, wherein the conductive layer is formed from at least one of stainless steel, superalloy (INCONEL®), a FeCrAl alloy, and a conductive ceramic.

14. The self-heated catalytic reactor of claim 1, wherein the conductive layer is configured to withstand a temperature of at least 1000° C.

15. The self-heated catalytic reactor of claim 1, wherein the conductive layer has a resistance of between 0.05 Ohm to 100 Ohm.

16. The self-heated catalytic reactor of claim 1, wherein the conductive layer has a thickness of between 20 micrometers and 400 micrometers.

17. The self-heated catalytic reactor of claim 1, wherein the conductive layer is a corrugated conductive layer.

18. The self-heated catalytic reactor of claim 1, wherein:
the insulator layer is formed from at least one of ceramic, glass, mica, and a combination thereof; and
the insulator layer is in the form of a sheet, a cloth, a screen, or a mat.

19-20. (canceled)

21. A catalytic heating system using fuel and oxidant to generate heat, the catalytic heating system comprising:
a self-heated catalytic reactor comprises a conductive layer, an insulator layer, a catalyst layer, a first electrode, and a second electrode, wherein:
the conductive layer comprises a first end and a second end, opposite of the first end, wherein the first end and the second end define a length of the conductive layer,
the insulator layer forms a stack together with the conductive layer, wherein each pair of adjacent layers of the conductive layer in the stack is separated by the insulator layer,
the catalyst layer is positioned on and supported on at least the conductive layer,
the first electrode is electrically coupled to the conductive layer at the first end, and
the second electrode is electrically coupled to the conductive layer at the second end;
a power supply electrically coupled to the first electrode and the second electrode of the self-heated catalytic reactor;
a thermocouple configured to measure temperature in the catalytic heating system corresponding to temperature of the self-heated catalytic reactor; and
a system controller communicatively coupled to the power supply and the thermocouple and configured to instruct the power supply to provide electrical power between the first electrode and the second electrode in response to the temperature of the self-heated catalytic reactor received from the thermocouple.

22-24. (canceled)

25. A method of operating a catalytic heating system comprising a self-heated catalytic reactor, a power supply, a thermocouple, and a system controller, the method comprising:
determining temperature of the self-heated catalytic reactor using the thermocouple, wherein the self-heated catalytic reactor comprises a conductive layer, an insulator layer, a catalyst layer, a first electrode, and a second electrode, wherein:
the conductive layer comprises a first end and a second end, opposite of the first end, wherein the first end and the second end define a length of the conductive layer,
the insulator layer forms a stack together with the conductive layer, wherein each pair of adjacent layers of the conductive layer in the stack is separated by the insulator layer,
the catalyst layer is positioned on and supported on at least the conductive layer,
the first electrode is electrically coupled to the conductive layer at the first end, and
the second electrode is electrically coupled to the conductive layer at the second end;
activating the power supply and supplying electrical power between the first electrode and the second electrode using the power supply when the temperature of the self-heated catalytic reactor is below a first threshold, thereby resistively heating the conductive layer;
flowing fuel and oxidant into the self-heated catalytic reactor when the temperature of the self-heated catalytic reactor reaches the first threshold; and
deactivating the power supply and stopping supplying the electrical power between the first electrode and the second electrode when the temperature of the self-heated catalytic reactor reaches a second threshold.

26-30. (canceled)
